(19) United States
(12) Patent Application Publication
(10) Pub. No.: US 2011/0283193 A1
(43) Pub. Date: Nov. 17, 2011

(54) METHOD AND APPARATUS FOR PROVIDING AN AUTOMATED CONTENT TIME-SHARING SERVICE

(76) Inventor: Linda Wright, Denver, CO (US)

(21) Appl. No.: 13/192,132

(22) Filed: Jul. 27, 2011

Related U.S. Application Data
(62) Division of application No. 12/128,780, filed on May 29, 2008.

(51) Int. Cl. G06F 3/00

(52) U.S. Cl. 715/733

(57) ABSTRACT

A method and apparatus for providing an automated content time-sharing service to a plurality of participants are disclosed. A user accesses a service platform, (e.g., via a Web site), that provides the service, and selects content, (e.g., a written, audible and/or visual work), offered by the service platform. The user interacts with the service platform for scheduling access to portions of the selected content, and identifying and grouping participants, (which may include the user), whom are to be granted access to the content portions. The user may also further interact with the service platform to generate content portion-forming information, (e.g., number and/or order of content portions). A dedicated Web space is provided for each group of participants to access and post communications about the selected content portions. The communications are then are archived according to the time interval during which the communications were posted.

### CROSS REFERENCE TO RELATED APPLICATION

This application is a divisional of U.S. patent application Ser. No. 12/128,780 filed May 29, 2008, which is incorporated by reference as if fully set forth.

### FIELD OF INVENTION

The present invention is generally related to a service platform that allows a user to select content, (e.g., a written, audible and/or visual work), that may be shared among a plurality of participants whom are granted access to an automated content time-sharing service. More particularly, the present invention is related to scheduling portions of selected content during different time intervals, and forming groups of participants that share these portions and exchange communications during the time intervals.

### BACKGROUND

The social act of assembly is the most fundamental aspect of sharing. Today, everyone can easily be a participant. The Internet has collapsed common obstacles (i.e. coordination, organization, and communication) that once prevented people from getting together. However, sharing also involves cooperation. For instance, when two or more people carry on a conversation, they are cooperating with each other as participants of the conversation. As New York University scholar Clay Shirky states in his book, Here Comes Everybody, “Cooperating is harder than simply sharing, because it involves changing your behavior to synchronize with people who are changing their behavior to synchronize with you. Unlike sharing, where the group is mainly an aggregate of participants, cooperating creates group identity—you know who you are cooperating with.” Nowhere is this more critical than in the sharing of content.

Hereinafter, the terminology “content” refers to a written, audible and/or visual work created for public consumption. For example, content may include, but is not limited to, literary, dramatic, musical, artistic, educational, and other intellectual works, both published and unpublished.

Service platforms, (e.g., the Internet, cable television, telephone networks), make it easy for people to assemble by providing numerous services such as email, YouTube, Facebook, Google and the like. Unfortunately, these service platforms do not provide a way to synchronize access to content with one or more groups of participants.

In a recent New York Times article, The Closing of the American Book, Andrew Solomon challenges content creators and the public to create a new social dimension for twenty-first century books. He said, “We need to make reading, which is in its essence a solitary endeavor, a social one as well, to encourage that great thrill of finding kinship in shared experiences of books. We must weave reading back into the very fabric of the culture, and make it a mainstay of community.” Therefore, it would be desirable to provide the capability of cooperatively using content to nourish and enliven friendship, kinship and community. For example, books could be recast as a way to connect with others.

### SUMMARY

The present invention is related to a method and an apparatus for providing an automated content time-sharing service. A user accesses a service platform, (e.g., via a Web site), that provides the service. The user selects content, (e.g., a written, audible and/or visual work), offered by the service platform. The user interacts with the service platform to generate scheduling information, (e.g., time intervals and/or a start date), for scheduling access to portions of the selected content, and participant group-forming information, (e.g., maximum number of participants and/or maximum number of groups of participants). The user may also further interact with the service platform to generate content portion-forming information, (e.g., number and/or order of content portions).

The service platform is configured to automatically provide at least one dedicated Web space for the participants, (which may include the user), to access a first portion of the selected content during a first time interval defined by the scheduling information. The participants may enter, review and/or edit communications, (e.g., about the first portion of the selected content), via the dedicated Web space during the first time interval). The service platform associates the communications with the first time interval and archives the communications. The service platform automatically provides the participants with access to additional portions of the selected content during subsequent time intervals defined by the scheduling information until the participants have access to all portions of the selected content. The participants may enter, review and/or edit communications, (e.g., about the additional portions of the selected content), via the dedicated Web space during the subsequent time intervals. The service platform associates each particular one of the communications with the time interval during which the particular communication was entered and archives the communications.

The service platform may calculate a licensing fee based on at least one of the selected content, the scheduling information, the participant group-forming information and the content portion-forming information. The service platform then would offer the automated content time-sharing service in return for the calculated licensing fee. The user interacts with the service platform to generate payment information for paying the licensing fee, and the service platform processes payment of the fee.

The user may also interact with the service platform to generate contact information for the participants. The service platform may then use the contact information to send a message to the participants specifying when access to the selected content will become available.

### BRIEF DESCRIPTION OF THE DRAWINGS

A more detailed understanding of the invention may be had from the following description, given by way of example and to be understood in conjunction with the accompanying drawings wherein:

FIGS. 1A, 1B and 1C, taken together, are a flow diagram of a method of providing an automated content time-sharing service;

FIG. 2 shows a service platform having a user interface for interfacing with a user, and a participant interface for interfacing with a plurality of participants identified by the user;

FIG. 3 shows an example of using the service platform to automatically send a message inviting the participants to access content portions during a first time interval and the subsequent time intervals;

FIGS. 4A and 4B show an example of providing two groups of participants with access to chapters, (i.e., portions), of the written work “Treasure Island”, (i.e., the selected content), over a plurality of time intervals; and

FIGS. 5A and 5B show an example of providing two groups of participants with access to selected songs, (i.e., portions), of the audible work “The White Album”, (i.e., the selected content), over a plurality of time intervals.

### DETAILED DESCRIPTION

Hereinafter, the terminology “content portions” refers to, but is not limited to, distinct sections of a written, audible and/or visual work, such as chapters of a written work, episodes of a dramatic work, songs of a music album, and images of an artistic work.

The present invention provides an automated content time-sharing service that allows people, (i.e., participants), to read, view and/or listen to portions of content selected by a user at scheduled time intervals and share the experience with each other. Thus, the present invention provides a participant interface for making reading, viewing and/or listening to, (i.e., experiencing), content a social endeavor.

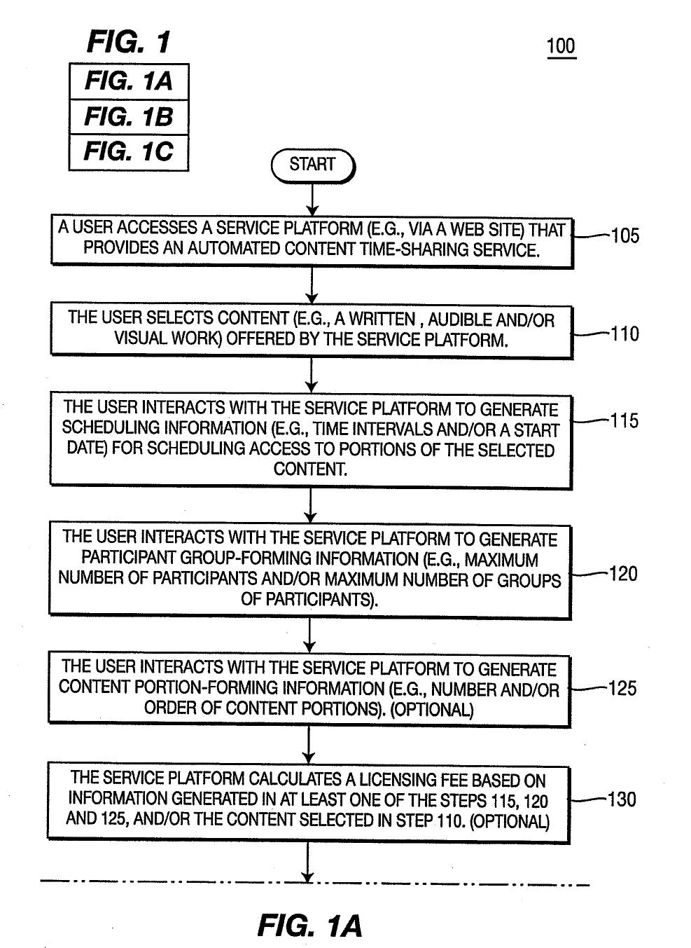

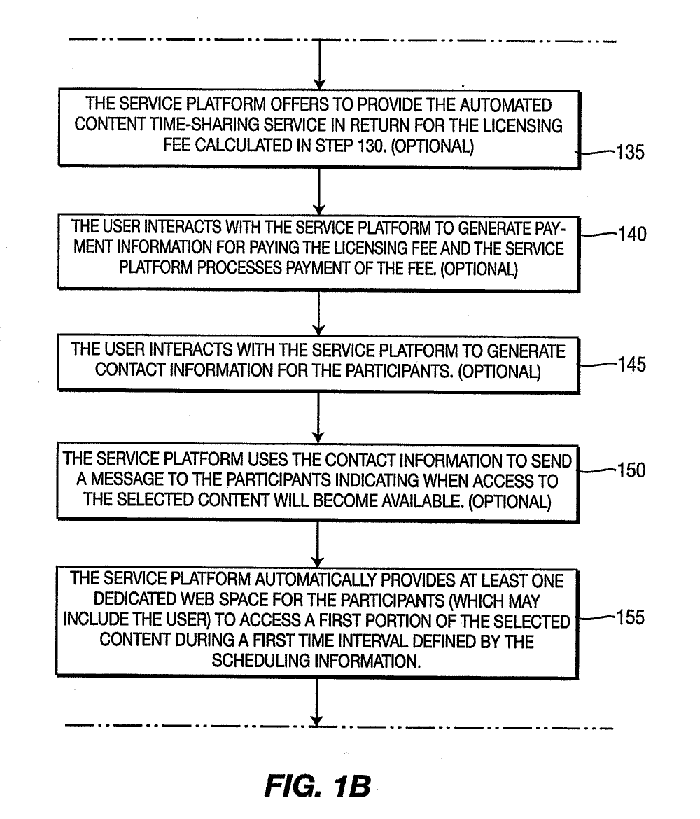

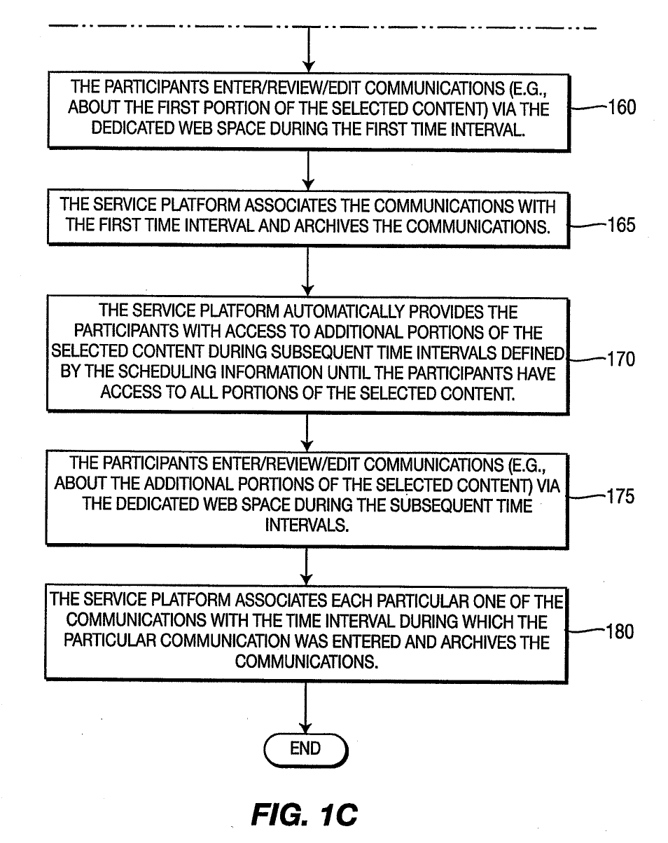

FIGS. 1A, 1B and 1C, taken together, are a flow diagram of a method 100 of providing an automated content time-sharing service in accordance with the present invention. The method 100 is provided as an example only. The steps of the method 100 may be implemented in any order desired, and many of the steps are optional, as determined by the user and/or the programmer of a service platform that performs the method 100.

Referring to FIG. 1A, a user accesses a service platform, (e.g., via a Web site), that provides an automated content time-sharing service (step 105). In step 110, the user selects content, (e.g., a written, audible and/or visual work), offered by the service platform. In step 115, the user interacts with the service platform to generate scheduling information, (e.g., time intervals and/or a start date), for scheduling access to portions of the selected content. In step 120, the user interacts with the service platform to generate participant group-forming information, (e.g., maximum number of participants and/or maximum number of groups of participants). Optionally, in step 125, the user may also further interact with the service platform to generate content portion-forming information, (e.g., number and/or order of content portions). In optional step 130, the service platform may calculate a licensing fee based on at least one of the selected content, the scheduling information, the participant group-forming information and the content portion-forming information.

Referring now to FIG. 1B, if optional step 130 is implemented, the service platform may offer to provide the automated content time-sharing service in return for the licensing fee (step 135). Then, in optional step 140, the user may interact with the service platform to generate payment information for paying the licensing fee and the service platform processes payment of the fee. Furthermore, in optional step 145, the user may interact with the service platform to generate contact information for the participants, (e.g., email addresses, telephone numbers). In optional step 150, the service platform may use the contact information to send a message to the participants indicating when access to the selected contact will become available. In step 155, the service platform automatically provides at least one dedicated Web space for the participants, (which may include the user), to access a first portion of the selected content during a first time interval defined by the scheduling information.

Referring now to FIG. 1C, in step 160, the participants may enter, review and/or edit communications, (e.g., about the first portion of the selected content), via the dedicated Web space during the first time interval). In step 165, the service platform associates the communications with the first time interval and archives the communications. In step 170, the service platform automatically provides the participants with access to additional portions of the selected content during subsequent time intervals defined by the scheduling information until the participants have access to all portions of the selected content. In step 175, the participants may enter, review and/or edit communications, (e.g., about the additional portions of the selected content), via the dedicated Web space during the subsequent time intervals. In step 180, the service platform associates each particular one of the communications with the time interval during which the particular communication was entered and archives the communications.

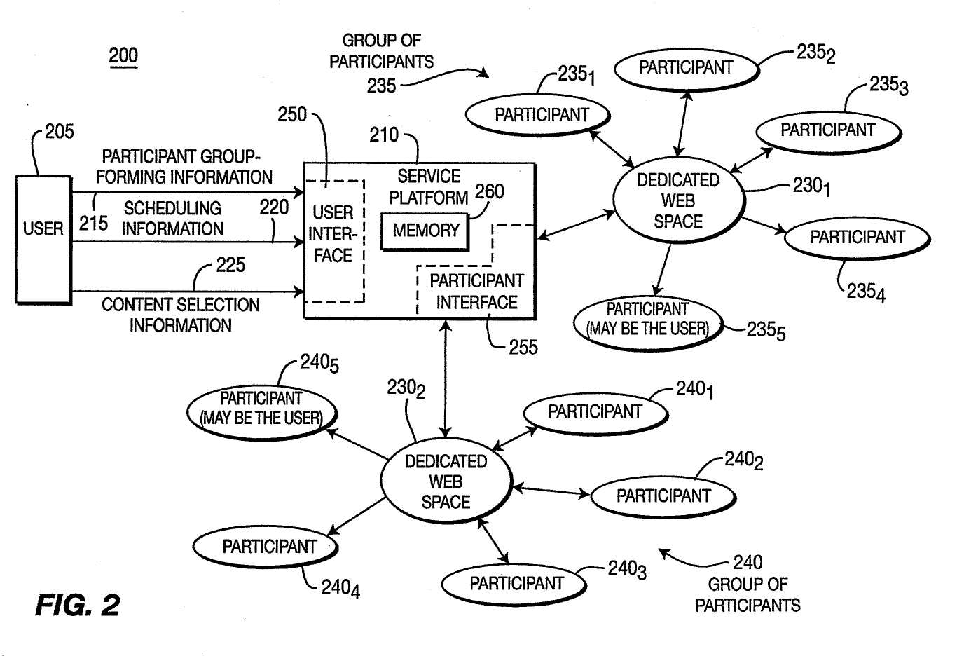

FIG. 2 shows a service platform 210 including a user interface 250 for interfacing with a user 205 and a participant interface 255 for interfacing with a plurality of participants 235₁, 235₂, 235₃, 235₄, 235₅, 240₁, 240₂, 240₃, 240₄ and 240₅, that are identified by the user 205, via dedicated Web spaces 230₁ and 230₂. The service platform 210 provides an automated content time-sharing service.

As shown in FIG. 2, the user interface 250 is configured to interact with the user 205 to generate scheduling information 220 and content selection information 225. The participant interface 255 is configured to automatically provide the plurality of participants 235₁, 235₂, 235₃, 235₄, 235₅, 240₁, 240₂, 240₃, 240₄ and 240₅ with access to a first portion of selected content during a first time interval defined by the scheduling information 220, and automatically provide the participants 235₁, 235₂, 235₃, 235₄, 235₅, 240₁, 240₂, 240₃, 240₄ and 240₅ with access to additional portions of the selected content during subsequent time intervals defined by the scheduling information 220.

Still referring to FIG. 2, the user interface 250 is further configured to interact with the user to generate participant group-forming information 215, which may specify a maximum number of participants 235₁, 235₂, 235₃, 235₄, 235₅, 240₁, 240₂, 240₃, 240₄ and 240₅ and a maximum number of groups of participants 235 and 240. The participant interface 255 automatically provides at least one dedicated Web space 230₁ and 230₂ that allows each participant 235₁, 235₂, 235₃, 235₄, 235₅, 240₁, 240₂, 240₃, 240₄ and 240₅, defined by the participant group-forming information 215, to access the portions of the content and share communications with other participants of their respective groups. Each particular one of the communications is associated with the time interval during which the particular communication was entered. The service platform 210 further comprises a memory 260 for archiving the communications, wherein the participants can review all of the archived communications via the participant interface.

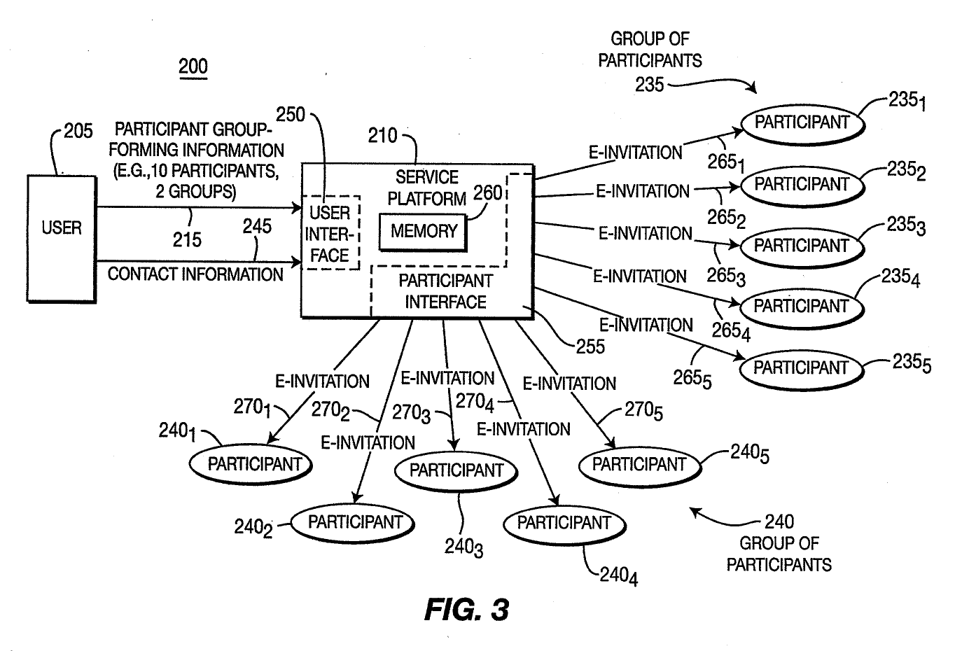

FIG. 3 shows an example of using the service platform 210 to automatically send a message (e.g., e-invitation) inviting the participants 235₁, 235₂, 235₃, 235₄, 235₅, 240₁, 240₂, 240₃, 240₄ and 240₅ to access content portions during a first time interval and subsequent time intervals. In this example, the user 205 accesses the service platform 210 and interacts with the user interface 250 to generate participant group-forming information 215 specifying a maximum number of ten (10) participants and a maximum of two (2) groups of participants. The user 205 further provides contact information 245 for the participants to the service platform, and the service platform 210 automatically sends a message 265₁, 265₂, 265₃, 265₄, 265₅, 270₁, 270₂, 270₃, 270₄ and 270₅, inviting the participants 235₁, 235₂, 235₃, 235₄ and 235₅ of a first group 235, and participants 240₁, 240₂, 240₃, 240₄ and 240₅ of a second group 240, to access the content portions during the first time interval and the subsequent time intervals.

The service platform 210 may be comprised by a cable television network or a telephone network. As an example, the user 205 may desire to set up, through a service offered by a cable television provider, which episode, (i.e., portion), of a television series, (i.e., content), such as “Star Trek”, is broadcast at time intervals specified by the user 205 to the cable television set-top boxes of ten (10) participants, one of which belongs to the user 205. Furthermore, via dedicated Web spaces displayed in a small dedicated area of the television screen, each participant could enter communications to share their thoughts of the episode (or anything else) with the other participants, while watching the episode. As another example, the user 205 may desire to set up, through a service offered by a telephone service provider, which song, (i.e., portion), of a music album, (i.e., content), such as “The White Album” by the Beatles, is played at time intervals specified by the user 205 after dialing the telephone numbers of wireless telephones associated with five (5) different participants, one of which belongs to the user 205. Furthermore, via dedicated Web spaces displayed on screens of the wireless telephones, or via a voice channel established to play the song, each participant could enter communications to share their thoughts about the song (or anything else) with the other participants before the song is played, while the song is played and/or after the song is played.

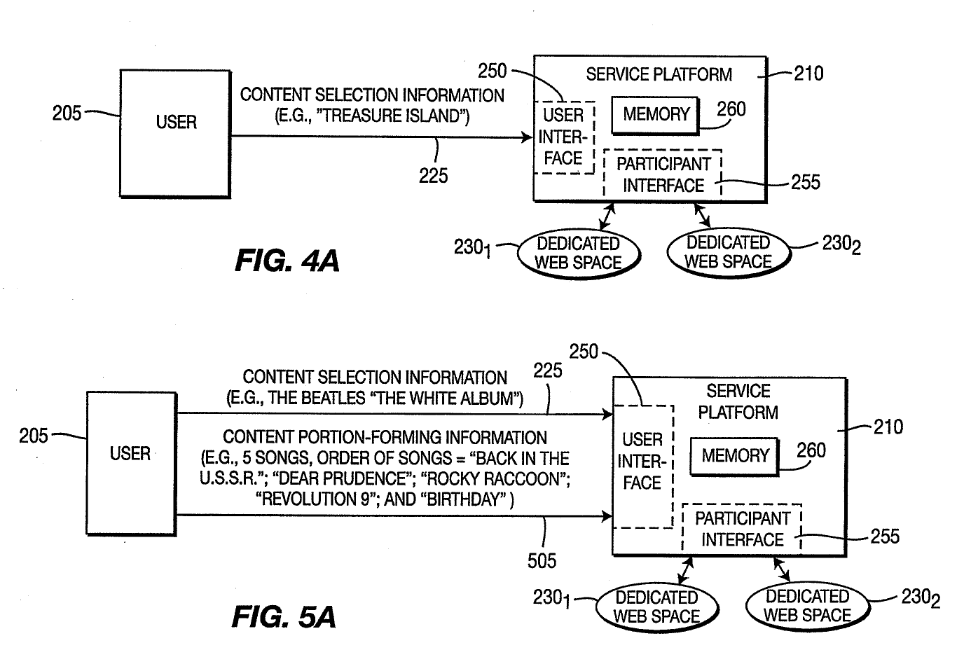

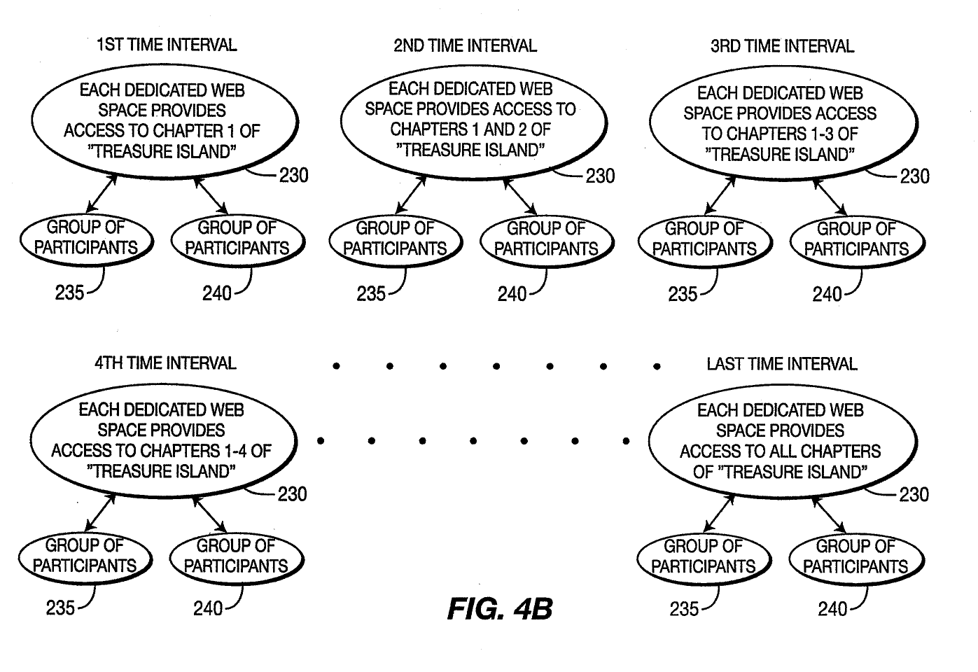

FIGS. 4A and 4B show an example of providing two groups of participants 235 and 240 with access to chapters, (i.e., portions), of the written work “Treasure Island”, (i.e., the selected content), over a plurality of time intervals. As shown in FIG. 4A, an automated content time-sharing service is provided by the user 205 accessing the service platform 210 and specifying “Treasure Island” in the content selection information 225. As shown in FIG. 4B, the service platform 210 automatically provides two groups of participants 235 and 240 with access to a first portion, (e.g., chapter 1), of “Treasure Island” during a first time interval via the dedicated Web spaces 230. The service platform 210 automatically provides the two groups of participants 235 and 240 with access to additional portions of the selected content via the dedicated Web spaces 230 during subsequent time intervals defined by the scheduling information. During a second time interval, both chapters 1 and 2 of “Treasure Island” are made accessible to the two groups of participants 235 and 240. During a third time interval, chapters 1-3 of “Treasure Island” are made accessible to the two groups of participants 235 and 240. During a fourth time interval, chapters 1-4 of “Treasure Island” are made accessible to the two groups of participants 235 and 240. And finally, during the last time interval, all chapters of “Treasure Island” are made accessible to the two groups of participants 235 and 240.

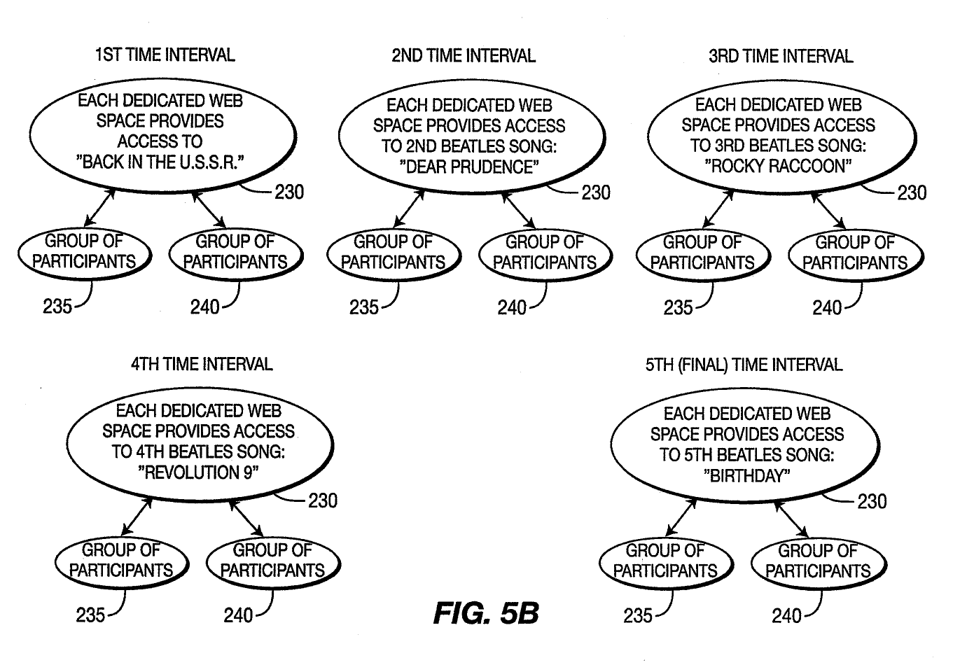

FIGS. 5A and 5B show an example of providing two groups of participants with access to selected songs, (i.e., portions), of an audible work “The White Album” by the Beatles, (i.e., the selected content), over a plurality of time intervals. In this example, the selected content is quite lengthy, having numerous songs on two discs as follows:

DISC 1:
1) “Back In The U.S.S.R.”;
2) “Dear Prudence”;
3) “Glass Onion”;
4) “Ob-La-Di, Ob-La-Da”;
5) “Wild Honey Pie”;
6) “Continuing Story Of Bungalow Bill, The”;
7) “While My Guitar Gently Weeps”;
8) “Happiness Is A Warm Gun”;
9) “Martha My Dear”;
10) “I'm So Tired”;
11) “Blackbird”;
12) “Piggies”;
13) “Rocky Raccoon”;
14) “Don't Pass Me By”;
15) “Why Don't We Do It In The Road?”;
16) “I Will”; and
17) “Julia”.

DISC 2:
1) “Birthday”;
2) “Yer Blues”;
3) “Mother Nature's Son”;
4) “Everybody's Got Something To Hide Except Me And My Monkey”;
5) “Sexy Sadie”;
6) “Helter Skelter”;
7) “Long, Long, Long”;
8) “Revolution 1”;
9) “Honey Pie”;
10) “Savoy Truffle”;
11) “Cry Baby Cry”;
12) “Revolution 9”; and
13) “Good Night”.

As shown in FIG. 5A, the service platform 210 comprises a user interface 250 configured to interact with a user 205 to generate content selection information 225 and content portion-forming information 505 that specifies how access to portions of the selected content will be provided to a plurality of participants over a plurality of scheduled time intervals. The service platform 210 further comprises a participant interface 255 configured to automatically provide, to the participants, access to portions of the selected content in accordance with the content selection information 225 and content portion-forming information 505.

In the example of FIGS. 5A and 5B, the content portion-forming information 505 specifies a number of portions, (e.g., five songs), of the selected content, (“The White Album” by the Beatles). Each portion is first provided for access during one of the scheduled time intervals. The content portion-forming information 505 specifies an order of portions of the selected content, (e.g., “Back in the U.S.S.R.”; “Dear Prudence”; “Rocky Raccoon”; “Revolution 9”; and “Birthday”). Each content portion is first provided for access during one of the scheduled time intervals.

As shown in FIG. 5B, the service platform 210 automatically provides two groups of participants 235 and 240 with access to a first portion, (e.g., “Back in the U.S.S.R.”), of “The White Album”, (i.e., the selected content), during a first time interval via the dedicated Web spaces 230. The service platform 210 automatically provides the two groups of participants 235 and 240 with access to additional portions of the selected content via the dedicated Web spaces 230 during subsequent time intervals defined by the scheduling information. During a second time interval, “Dear Prudence” is made accessible to the two groups of participants 235 and 240. During a third time interval, “Rocky Raccoon” is made accessible to the two groups of participants 235 and 240. During a fourth time interval, “Revolution 9” is made accessible to the two groups of participants 235 and 240. And finally, during the fifth and final time interval, “Birthday” is made accessible to the two groups of participants 235 and 240.

Alternatively, the user 205 may specify, in the content portion-forming information 505, multiple portions of content that are made accessible in each time interval. For example, three (3) songs could be made available to the participants on a daily basis. Access to the content portions of each time interval may be accumulative, as has been previously described for the example of the chapters of “Treasure Island”, or each time interval may include content portions that are completely different from content portions that were previously accessible in previous time intervals.

Although the present invention has been described in detail by reference to the preferred embodiment, it is to be understood that the invention is not limited thereto, and that various changes can be made therein without departing from the spirit and scope of the invention, which is defined by the attached claims.

What is claimed is:

1. A method of providing an automated content time-sharing service, the method comprising:
a user accessing a service platform;
the user selecting content offered by the service platform; and
the user interacting with the service platform to generate content portion-forming information that specifies how access to portions of the selected content will be provided to a plurality of participants over a plurality of scheduled time intervals.

2. The method of claim 1 wherein the content portion-forming information specifies a number of portions of the selected content, each portion first being provided for access during one of the scheduled time intervals.

3. The method of claim 1 wherein the content portion-forming information specifies an order of portions of the selected content, each portion first being provided for access during one of the scheduled time intervals.

4. The method of claim 1 wherein the content portion-forming information specifies a number of portions of the selected content provided for access during each of the scheduled time intervals.

5. The method of claim 1 further comprising:
automatically providing, to the participants, access to portions of the selected content in accordance with the content selection information and content portion-forming information.

6. The method of claim 1 wherein the method is implemented by a cable television network.

7. The method of claim 1 wherein the method is implemented by a telephone network.

8. The method of claim 1 wherein the portions of the selected content are sections of a written work.

9. The method of claim 1 wherein the portions of the selected content are sections of an audible work.

10. The method of claim 1 wherein the portions of the selected content are sections of a visual work.

11. A service platform for providing an automated content time-sharing service, the service platform comprising:
a user interface configured to interact with a user to generate content selection information and content portion-forming information that specifies how access to portions of the selected content will be provided to a plurality of participants over a plurality of scheduled time intervals.

12. The service platform of claim 11 wherein the content portion-forming information specifies a number of portions of the selected content, each portion first being provided for access during one of the scheduled time intervals.

13. The service platform of claim 11 wherein the content portion-forming information specifies an order of portions of the selected content, each portion first being provided for access during one of the scheduled time intervals.

14. The service platform of claim 11 wherein the content portion-forming information specifies a number of portions of the selected content provided for access during each of the scheduled time intervals.

15. The service platform of claim 11 further comprising:
a participant interface configured to automatically provide, to the participants, access to portions of the selected content in accordance with the content selection information and content portion-forming information.

16. The service platform of claim 11 wherein the service platform is comprised by a cable television network.

17. The service platform of claim 11 wherein the service platform is comprised by a telephone network.

18. The service platform of claim 11 wherein the portions of the selected content are sections of a written work.

19. The service platform of claim 11 wherein the portions of the selected content are sections of an audible work.

20. The service platform of claim 11 wherein the portions of the selected content are sections of a visual work.

21. A service platform for providing an automated content time-sharing service, the service platform comprising:
a user interface configured to interact with a user to generate information that specifies how access to portions of the selected content will be provided to a plurality of participants over a plurality of scheduled time intervals; and
a participant interface configured to automatically provide, to the participants, access to portions of the selected content.
